(19) United States
(12) Patent Application Publication
(10) Pub. No.: US 2021/0078845 A1
(43) Pub. Date: Mar. 18, 2021

(54) ANTI-EXTRUSION DEVICE AND AERIAL WORK PLATFORM

(71) Applicant: ZHEJIANG DINGLI MACHINERY CO., LTD, Huzhou (CN)

(72) Inventor: Shugen XU, Huzhou (CN)

(21) Appl. No.: 16/751,278

(22) Filed: Jan. 24, 2020

(30) Foreign Application Priority Data
Sep. 16, 2019 (CN) 2019108707704

(51) Int. Cl. B66F 17/00; E04G 5/14; E04G 5/00; B66F 11/04

(52) U.S. Cl. CPC B66F 17/006; B66F 11/044; E04G 5/001; E04G 5/14

(57) ABSTRACT

The present disclosure relates to the technical field of anti-extrusion systems, in particular to an anti-extrusion device and an aerial work platform. It includes an operation platform guard for a guard rail mounted on an aerial work platform, the operation platform guard is movably connected to at least one detecting rod for the human body to lean on, and the detecting rod is provided with a position change sensing means for triggering an alarm system.

### TECHNICAL FIELD

The present disclosure relates to the technical field of anti-extrusion systems, and in particular to an anti-extrusion device and an aerial work platform.

### BACKGROUND

Aerial work platforms are used more and more frequently in today's society, and more attention is paid on its safety. In particular, when obstacles appear on the top or rear of the platform, and when it is likely that the operator ignores and the machine continues to rise, the worker may be squeezed by the obstacle. The machine may continue to lift due to the operator's inability to release the operating handle in time, eventually causing a more serious accident, etc., in the prior art. There is such a safety facility against squeezing existing in the prior art.

For example, the work platform anti-extrusion system and the aerial work platform are disclosed in Chinese Patent with Publication No. CN208249834U, the work platform anti-extrusion system is provided on the work platform, and the work platform includes an operation platform, and an anti-extrusion drawstring located at the rear side of the work platform and connected to the work platform at its both ends. At least one end of the anti-extrusion drawstring is connected with a rope switch disposed on the work platform, the rope switch is connected to the upper controller, the upper controller has a platform movement stop module. The utility model has the advantages that: the anti-extrusion drawstring connected with the rope switch detects the squeezed condition, the detection mode is contact type, and is not easy to be triggered by mistake. But the structure is easy to injure the human body, and the structures of the rope switch and the drawstring are easy to be damaged with poor recovery;

A work platform for preventing continuous involuntary operation disclosed in Chinese Patent with Publication No. CN107257773A, comprises: a floor structure having a width dimension and a depth dimension; and a safety barrier coupled to the floor structure, a control panel area being capable to cooperates with the safety barrier and including a sensor support rod having a top crossbar extending along the width dimension, and a side bar extending substantially perpendicularly from the top crossbar, each of the side bars includes an upper portion extending inwardly from the top crossbar along the depth dimension to a curved portion, and a lower portion extending outwardly from the curved portion along the depth dimension to the safety barrier, configured to be a platform switch that trips when a predetermined force is applied is attached to the sensor support rod through a switch rod, the switch rod is held by the shearing element. The entire structure is a fixed structure, and the rigidity is large, especially when there is a large pressing force, it can alert, the impact on the person is still large, and the position of the human body is limited, the risk-avoiding effect is not good enough.

### SUMMARY

One object of the present disclosure is to provide a safer anti-extrusion device.

The above technical object of the present disclosure is achieved by the following technical solutions: an anti-extrusion device is provided, including an operation platform guard for a guard rail mounted on an aerial work platform, the operation platform guard is movably connected to at least one detecting rod for the human body to lean on, and the detecting rod is provided with a position change sensing means for triggering an alarm system.

Regarding the above solution, when the operator is or is about to be squeezed, the operator can push the detecting rod through the leaning of the body, so that the position of the detecting rod changes to notify the alarm system that the operator is in danger. In the situation, the continuous operation of the work platform is then shut down, and the change of the position information of the detecting rod is detected by the position change sensing means and fed back to the alarm system, so that the human body can not only have a certain safe movement space, but also alarm can be effective and safety is improved.

As a preferred aspect of the present disclosure, the detecting rod is rotatably coupled to the operation platform guard.

As a preferred aspect of the present disclosure, the operation platform guard is fixed with a hinged seat for hinging the detecting rod.

As a preferred aspect of the present disclosure, the hinged seat is mounted with a limit device for limiting the detecting rod.

As a preferred aspect of the present disclosure, the limiting device includes a front side limiting block for restricting the detecting rod from swinging toward the operation platform, and a rear side limiting plate for restricting the detecting rod from swinging toward the operator; between the front side limiting block and the rear side limiting plate, a free movable interval for the detecting rod to swing is provided.

As a preferred aspect of the present disclosure, the rear side limiting plate is part of the hinged seat.

As a preferred aspect of the present disclosure, the hinged seat is mounted with an elastic reset device for resetting the detecting rod.

As a preferred aspect of the present disclosure, the detecting rod abuts against the rear side limiting plate.

As a preferred aspect of the present disclosure, the anti-extrusion device has two detecting rods that are opposite to each other and are provided with position change sensing means at opposite ends.

As a preferred aspect of the present disclosure, the position change sensing means on one of the detecting rods is a magnetic inductive switch, and the position change sensing means on the other detecting rod is a magnetic block.

As a preferred aspect of the present disclosure, at least a portion of a surface of the detecting rod is an arcuate portion that is in contact with the operator.

As a preferred aspect of the present disclosure, an outer portion of the detecting rod is wrapped with a buffer layer.

Another object of the present disclosure is to provide a higher security aerial work platform.

The above technical object of the present disclosure is achieved by the following technical solutions: an aerial work platform is provided, it has a base for an operator to stand and a guard rail mounted on the base, the guard rail is mounted with the aforementioned anti-extrusion device.

Advantageous effects of the present disclosure is listed as below:

The structure of the present application is higher in safety, the correctness of the alarm triggering is higher, the protection of the human body and the equipment itself is better in the anti-squeeze and risk avoidance process, the stability and restorative property of the structure are better, and not easy to damage during long-term use.

### BRIEF DESCRIPTION OF THE DRAWINGS

FIG. 1 is a partial perspective view of the anti-extrusion device mounted on an aerial work platform of Embodiment 1 according to the present disclosure;

FIG. 2 is an enlarged view of Portion I in FIG. 1;

FIG. 3 is a partial perspective structural view showing a region where the detecting rod 2 is located, which is observed from the front side view of Embodiment 1 according to the present disclosure.

FIG. 4 is a schematic perspective view of Embodiment 4 according to the present disclosure.

In the figures:
1, operation platform guard; 2, Detecting rod; 3, Position change sensing means; 4, Hing seat; 5, Limiting device; 51, Front side limiting block; 52, Rear side limiting plate; 512, Free movable interval; 6, Elastic reset device; 20, Buffer layer; al, operation platform; 10, Guard frame; 11, Guard rod; 40, Hinged shaft; 400, Semi-enclosed guiding section; 41, Side plate; 42, Upper plate; 43, Lower plate; 4a, Upper rotating plate; 4b, Lower rotating plate; 4c, Side rotating plate; 60, Torsion spring; 7, Base; 8, Guard rail.

### DETAILED DESCRIPTION OF EMBODIMENTS

The following specific embodiments are merely illustrative of the present disclosure, and are not intended to limit the present disclosure. Those skilled in the art can make modifications to the present embodiment that are not creatively contributed as needed after reading the present specification, but they are protected by patent law when falling into the scope of the appendix claims.

### Embodiment 1

An anti-extrusion device is provided, it may include an operation platform guard 1 for a guard rail 8 mounted on an aerial work platform p1, the operation platform guard 1 can adopt an existing conventional guard, and an operation platform al is disposed in the protection area of the operation platform guard 1. The operation platform guard 1 can be movably connected with at least one detecting rod 2 for the human body to lean on, and one or two or even more detecting rods can be selected. These detecting rods 2 are initially kept still, when an abnormal situation occurs, for example, it is squeezed by an obstacle, the operator can touch the detecting rod 2 and push a distance to generate a position change. The detecting rod 2 is mounted with a position change sensing means 3 for triggering an alarm system, the position change sensing means 3 can issue a position change information to the alarm system to shut down the work platform, and can perform an alarm through devices such as an audible alarm and a light alarm, so that the squeezed condition can be timely dealt. The position change sensing means 3 can be connected to the alarm system through wired or wireless means, and trigger the alarm system by feedback position information change.

The detecting rod 2 may enables it to move between the operator and the operation platform. The design can, on one aspect, make the operator leans forward and leans down more conveniently and homeopathically; on the other aspect, the front side area is the area of the operation platform guard 1, it not only has a space for people to move forward, but also a cover for operating the platform guard 1, which can further improve safety.

The manner of the movable connection of the detecting rod 2 and the operation platform guard 1 can be directly realized by a compression connection structure such as a spring or a cylinder, and the initial state can be kept still. The operator can directly push the detecting rod 2 to be compressed or the cylinder, thereby the position of the detecting rod 2 is offset to alarm and shut down the work platform, and when the operator returns to the normal state after the emergency state eliminated. The detecting rod 2 can be effectively reset, but the simple structure is insufficient in stability. It is easy to be damaged, and it may cause abnormality of the detecting rod 2 or the position change sensing means 3, or there is a certain safety hazard.

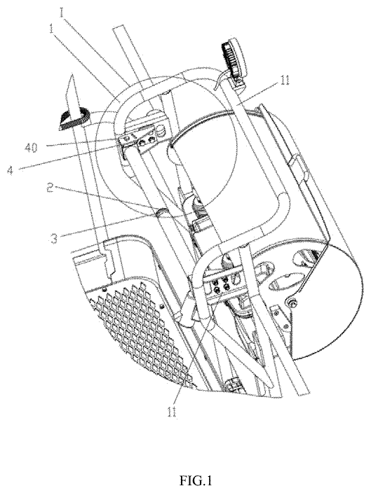

A more reliable connection method is preferred in this embodiment. As shown in FIG. 1, the detecting rod 2 is mounted on the operation platform guard 1 by means of a rotational connection, and preferably through the end portion of the detecting rod 2, to make the structure of rotational connection realized. The existing operation platform guard 1 is generally composed of two left and right guard frames 10 and a guard bar 11 which is bridged between the two guard frames 10 and is located above the two. One end of the detecting rod 2 is rotatably connected to one of the guard frames 10, so that the detecting rod 2 can be rotated around the guard frame 10. Further preferably, the operation platform guard 1 is fixed with a hinged seat 4 for hinging the detecting rod 2, the hinged seat 4 is mounted on the guard frame 10, and the hinged shaft 40 on the hing seat 4 may preferably be such that the positional offset is formed through the detecting rod 2 rotates around the hinge shaft 40 in a horizontal area or in a downwardly inclined area or in a vertically downward area. Furthermore, the hinged seat 4 is mounted with a limiting device 5 for limiting the detecting rod 2, and the movement range of the detecting rod 2 is limited by the limit of the limiting device 5, such that the rotation of the detecting rod 2 is merely a swing maintained within a certain range, that is, a position that restricts the initial state of the detecting rod 2 to an offset end position after the position of the detecting rod 2 is changed when the operator is in a squeezed state. Surely, the detecting rod 2 needs to be reset to the position of the initial state after the alarm ends, so the detecting rod 2 is capable of swinging back and forth between the two positions.

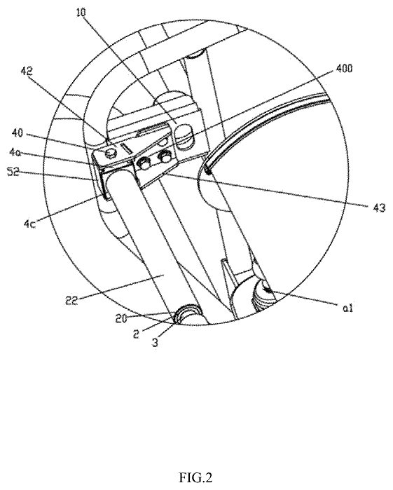

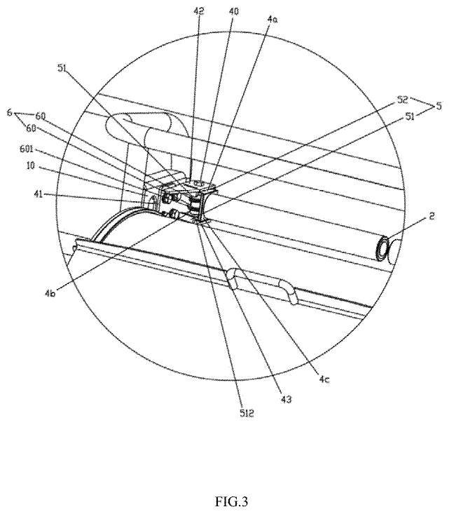

Specifically, preferably, the embodiment has a swinging manner of the detecting rod 2 in the area of the horizontal plane or in the area close to the horizontal plane. The hinged seat 4 may specifically include a side plate 41 fixedly mounted with the guard frame 10, and an upper plate 42 and a lower plate 43 integrally connected to the upper portion and the lower portion of the side plate respectively. The side plate 41, the upper plate 42 and the lower plate 43 are preferably located in a protective area between the left and right two guard frames 10 and the three are surrounded to form a semi-enclosed guiding section 400 used for the stable guiding of the detecting rod 2 when moving, and does not sway up and down. The upper plate 42 and the lower plate 43 are provided with the above-mentioned hinge shaft 40 extending upward and downward, and the hinge shaft 40 can directly pass from top to bottom through the detecting rod 2 and are connected in the end, but this connection is not conducive to the connection of the reset device described later, as shown in FIGS. 2 and 3.

Thus, preferably, a new hinged structure of the detecting rod 2 is further provided. That is, a rotating member is further added, the rotating member includes an upper rotating plate 4a and a lower rotating plate 4b, and a side rotating plate 4c integrally connected between the upper rotating plate 4a and a lower rotating plate 4b. The hinge shaft 40 passes from top to bottom through the upper rotating plate 4a and the lower rotating plate 4b, and the rotating member is disposed between the upper plate 42 and the lower plate 43 and can be rotated around the hinge shaft 40. The detecting rod 2 is preferably fixed to the side rotating plate 4c, so that the detecting rod 2 can move together with the rotating member. The detecting rod 2 can be fixed to the side rotating plate 4c by welding or socketing.

Preferably, the limiting device 5 includes a front side limiting block 51 for restricting the detecting rod 2 from swinging toward the operation platform, and a rear side limiting plate 52 for restricting the detecting rod 2 from swinging toward the operator. There is a free movable interval 512 for the detecting rod 2 to swing between the front side limiting block 51 and the rear side limiting plate 52. Wherein, one of the front side limiting blocks 51 may be integrally connected to the lower side of the upper plate 42 on the same hinge shaft 40, or one of the front side limiting blocks 51 may be integrally connected to the upper side of the lower plate 43, or each of the front side limiting blocks 51 is respectively integrally connected to the lower side of the upper plate 42 and the upper side of the lower plate 43 and vertically opposed to each other. The free movable interval 512 is such that the end of the detecting rod 2 or the rotating member can has a swingable space that can be rotated at the hinge shaft 40, and at the same time, the limits of initial state position and the end position are obtained at the rear side limiting plate 52 and the front side limiting block 51, for example, when the rotating member is used, both the upper rotating plate 4a and the lower rotating plate 4b of the rotating member may have a rear side edge that abuts against the rear side limiting plate 52 and a front side edge that abuts against the front side limiting block 51, or these two limiting movements are accomplished by the rear side edge and the front side edge of the side rotating plate 4c.

Preferably, the rear side limiting plate 52 is a part of the hinged seat 4, and the rear side limiting plate 52 may be integrally connected to the rear side portions between the upper plate 42 and the lower plate 43. The hinged seat 4 and the rotating member may be made of a hard material structural member such as a metal member or a polymer composite member.

In order to better keep the detecting rod 2 still in the initial state, and the detecting rod 2 can be pushed by the operator to the end position and the position change occurs, thereby alarm is generated, and the detecting rod 2 can be reset and reused. Then, the hinged seat 4 can be mounted with an elastic reset device 6 for resetting the detecting rod 2. Also preferably, in the initial state, the detecting rod 2 can abut against the rear side limiting plate 52. Surely, the detecting rod 2 can be realized by other reset mechanisms, either manually or automatically. This embodiment will introduce a simple and effective implementation subsequently.

Specifically, the elastic reset device 6 includes a torsion spring 60 sleeved on the periphery of the hinge shaft 40. For example, if the hinged seat 4 is mounted on the left side of the guard frame 10, the side plate 41 is then fixed with the guard frame 10. The semi-enclosed guiding section 400 faces to the right, the side rotating plate 4c can be located on the right side of the side plate 41, the torsion spring 60 is disposed at a position between the side plate 41 and the side rotating plate 4c, and both ends 601 of the torsion spring 60 are respectively penetratingly disposed on the side plate 41 and the side rotating plate 4c. After being connected, at the position of the initial state, the detecting rod 2 is abutted against the front side position of the rear side limit plate 52 by the elastic force of one end 601 of the torsion spring 60. However, when the operator needs an alarm, a certain pushing force is applied, so that the detecting rod 2 generates a position change toward the front side region to perform an alarm. After the alarm, the detecting rod 2 is reset depending on the resilience of the torsion spring 60 itself. The structure has the advantage that the detecting rod 2 needs to resist a certain torsion spring force, it can prevent false alarms caused by actions such as flicking during normal operation, and can be effectively reset. The position of the human body has more mobile hedging distance during forward or downward movement when the human body is squeezed. The structure, has a good buffering effect, damage to the equipment or the human body will not occur due to too much impact force. Surely, the outer periphery of the hinge shaft 40 can be sleeved with more than two torsion springs 60 for better force resistant, as shown in FIG. 3.

In addition, the mounting position of the hinged seat 4 and the rotating member or the like can be inclined forward and downward or arranged downward, so that the detecting rod 2 can swing forward and downward or just swings downward, which also has a good usage effect.

Assuredly, when used, it is generally required to operate with an existing foot switch. When the operator is squeezed, the detecting rod 2 is pushed by leaning, and the controller in the alarm system receives the information of the position change, and then controls the work platform to stop all functional movements. Generally, the controller controls the sound and light alarm to simultaneously emit an audible alarm and a light alarm to notify relevant personnel to perform the hedging process. The process of work can be carried out as follows:

Triggering: the detecting rod 2 is pushed to change the position and notify the controller in the alarm system, and the controller stops the movement of the work platform. At the same time, signals of the operation platform needs to be shielded;

Resetting: The reset state of the detecting rod 2 and the state of the foot switch can also be detected by the controller. If the detecting rod 2 is restored from the squeezed state to the normal initial state, and then foot switch is restored from the pedaling state to the non-pedaling state, and then entering the pedaling state, the controller begins to respond to signals from the operation platform.

When triggered, the controller also controls the sound and light alarm to alarm and detect the working state of the main arm. If the main arm is in the lifting state, the controller controls the main arm to stop lifting and falls within the predetermined falling time; if the main arm is at the extended state, the controller controls the main arm to stop extending and retract within the predetermined retraction time.

Upon recovery, the controller also controls the sound and light alarm to stop the alarm while beginning to respond to signals from the operation platform.

In addition, when the squeezing situation occurs, the aerial work platform p I can be able to descend to a certain height, thereby effectively preventing the worker from being injured; the recovery step requires successively resetting the detecting rod 2 and the foot switch to prevent the anti-extrusion system from the wrong recovery after being triggered.

### Embodiment 2

On the basis of Embodiment 1, considering the aesthetics, integrity, and reliability of the structure on the device, the anti-extrusion device preferably has two detecting rods 2 opposite to the left and right. The position change sensing means 3 are disposed at the opposite ends, and the detecting rod 2 can also be extended in the left and right direction. For reference, all the drawings in the first embodiment can be referred to.

The two left and right detecting rods 2 can be respectively mounted on the left and right two guard frames 10 through the mounting structure in Embodiment 1, and the design is further strengthened in structure. The safety is improved because any one of the detecting rods 2 is pushed, the alarm can be performed.

The position change sensing means 3 can be embedded in the end of the detecting rod 2, and the specific implementation scheme has various types, for example:

The position change sensing means 3 on one of the detecting rods 2 is a magnetic inductive switch, and the position change sensing means 3 on the other detecting rod 2 is a magnetic block. When any one of the detecting rods 2 is pushed or both of two detecting rods are pushed, the magnetic inductive switch will switch ON/OFF of the switch due to the change of position. Because the two are initially close to each other and have magnetic inductive, as long as one of the detecting rods 2 is pushed, the magnetic inductive will be weakened or disappeared and to generate a switch of ON/OFF. This switching information can be fed back to the controller to realize the alarm operation. In this case, the magnetic inductive switch can be electrically connected to the alarm system for feedback, because the change information of position of any one of the detecting rods 2 occurs, the change information can be fed back to the alarm system through the ON/OFF information of the magnetic inductive switch;

Alternatively, a displacement sensor with higher precision may be directly adopted as the position change sensing means 3, and when the position of the detecting rod 2 changes, it can be fed back to alarm;

Yet alternatively, the position change sensing means 3 on one of the detecting rods 2 may be set as an infrared receiver, and the position change sensing means 3 on the other detecting rod 2 may be set as an infrared emitter. When the receiving state of the infrared signal changes, this position change information can be fed back to the alarm where the infrared receiver can be electrically connected to the alarm system for feedback.

These schemes can be used in different scenarios. For example, the first type is not recommended in a place with a large magnetic field influence, and the design structure, selectivity, and applicability can be greatly improved.

### Embodiment 3

The difference between this embodiment and the above two embodiments is that, further to the design of the body of the detecting rod 2, at least a part of the surface of the detecting rod 2 is an arcuate portion which can be in contact with the operator. Therefore, the detecting rod 2 may be preferably a long cylindrical shape and has a horizontally-shaped rod structure, and the use effect is good. For the drawings, reference may be made to all the drawings in the first embodiment.

In addition, the outer portion of the detecting rod 2 may preferably also be wrapped with a buffer layer 20. The buffer layer 20 can be made of a flexible material such as sponge, latex, rubber or plastic to better protect the human body. The body of the detecting rod 2 can be a metal rod or a rigid plastic rod.

The detecting rod 2 is controlled as much as possible at about 30 cm, and should not be too long. The swinging distance of the detecting rod 2 is controlled within 15 cm as much as possible, and the angular range of the swing is controlled within 45 degrees.

### Embodiment 4

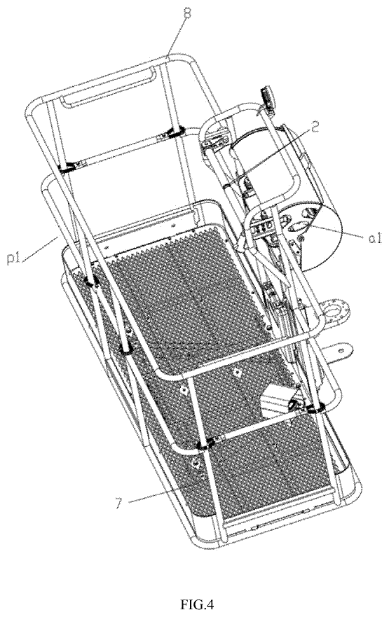

As shown in FIG. 4, an aerial work platform is provided. It has a base 7 for the operator to stand and a guard rail 8 mounted on the base 7, the guard rail 8 being mounted on the foregoing embodiment an anti-extrusion device is involved.

The main structure of the embodiment can adopt an existing work platform, and the difference lies in the installation of the anti-extrusion device of the new design of the present application.

The above description is only the specific embodiment of the present disclosure, but the scope of the present disclosure is not limited thereto, and any person skilled in the art can easily think of various kinds within the technical scope disclosed by the present disclosure. Equivalent modifications or substitutions are intended to be included within the scope of the present disclosure. Therefore, the scope of protection of the present disclosure should be determined by the scope of the claims.

What is claimed is:

1. An anti-extrusion device, wherein comprising: an operation platform guard (1) for a guard rail mounted on an aerial work platform; the operation platform guard (1) being movable connected with at least one detecting rod (2) for the human body to lean on, and the detecting rod (2) provided with a position change sensing means (3) for triggering an alarm system.

2. The anti-extrusion device according to claim 1, wherein the detecting rod (2) is rotatably connected to the operation platform guard (1).

3. The anti-extrusion device according to claim 2, wherein the operation platform guard (1) is fixed with a hinged seat (4) for hinging the detecting rod (2).

4. The anti-extrusion device according to claim 3, wherein the hinged seat (4) is provided with a limiting device (5) for limiting the detecting rod (2).

5. The anti-extrusion device according to claim 4, wherein the limiting device (5) comprises a front limiting block (51) for restricting the detecting rod (2) toward the operation platform, and a rear side limiting plate (52) for restricting the detecting rod (2) from swinging toward the operator; between the front side limiting block (51) and the rear side limiting plate (52), a free movable interval (512) for the detecting rod (2) to swing is provided.

6. The anti-extrusion device according to claim 5, wherein the rear side limiting plate (52) is part of the hinged seat (4).

7. The anti-extrusion device according to claim 4, wherein the hinged seat (4) is provided with an elastic reset device (6) for resetting the detecting rod (2).

8. The anti-extrusion device according to claim 1, wherein the anti-extrusion device has two detecting rods (2) opposite to each other, and are provided with position change sensing means (3) at opposite ends.

9. The anti-extrusion device according to claim 8, wherein the position change sensing means (3) on one of the detecting rods (2) is a magnetic inductive switch and the position change sensing means (3) on the other detecting rod (2) is a magnetic block.

10. An aerial work platform having a base (7) for an operator to stand and a guard rail (8) mounted on the base (7), wherein: the guard rail (8) is mounted with the anti-extrusion device.
